(19) United States
(12) Patent Application Publication
(10) Pub. No.: US 2004/0203387 A1
(43) Pub. Date: Oct. 14, 2004

(54) System and method for controlling appliances with a wireless data enabled remote control

(75) Inventor: Michael Grannan, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/403,796

(22) Filed: Mar. 31, 2003

(51) Int. Cl. H04B 7/00

(52) U.S. Cl. 455/41.2; 455/41.3

(57) ABSTRACT

A remote control apparatus includes a hand-held housing, an antenna, a user interface, a wireless data interface, a display device, and a processing unit. The antenna is coupled to the hand-held housing. The user interface includes input selection elements accessible to a user. The user may access these elements from a surface of the hand-held housing. The wireless data interface is located within the hand-held housing and coupled to the antenna. The wireless data interface communicated using a wireless data protocol to a residential gateway system. The display device is capable of being updated by program logic. The processing unit may control the display device, manage the wireless data interface, and process speech input for transmission over the wireless data interface.

### FIELD OF THE DISCLOSURE

The present application relates generally to a method and a system for controlling various appliances using a wireless data remote control.

### BACKGROUND

Remote controls have become prevalent and are commonly supplied with consumer electronics devices sold today, including televisions and DVD players. They have become so numerous that it is often a challenge for the average consumer to easily control all of the devices. Hence “smart remotes” that either store remote control codes for various makes and models of devices, or are capable of learning device specific codes, are available. As broadband Internet service (e.g. cable modem, DSL) becomes more ubiquitous, more homes will have a high-speed data server. Gateways and home servers are initially being installed to share the broadband connection among multiple computers or electronic devices in the home. Over time however, gateways will likely evolve to support more powerful functions, including the ability to remotely provision new services, and serving as a media appliance that stores and manages digital content a consumer may have purchased, from movies to music.

Accordingly, there will be a need in the home itself to facilitate utilizing this newfound power and capability of the gateway/home server and for an improved method of communicating with the gateway/home server while in the home.

### SUMMARY

The present disclosure relates generally to a method and system for controlling consumer electronics devices, computers, lighting, and appliances with a wireless data enabled remote control. In a particular embodiment, the system includes a home server product that includes a cable or DSL modem, built-in storage, a wireless data access point, an infrared transmitter, and an X10 transmitter. The home server is capable of controlling legacy devices such as a television supplied with its own unique remote control, or lighting plugged into a standard power outlet by way of an X10 module, by transmitting an infrared signal, or by sending a command over the power-line or in-house phone line, respectively. The home server provides a website for controlling such devices in the home, but is also responsive to commands from a wireless data enabled remote control. In one example, a consumer is capable of controlling a TV not by using the supplied remote directly, but by using a wireless data enabled remote control that sends commands to the home server. The home server, in turn, controls the electronics device by transmitting the infrared signals for the desired device.

In another particular embodiment, the system is interfaced via a control interface to a structured wiring installation permitting data transfer to consumer electronic devices. Examples include the Consumer Electronics Bus (CEBus) standard, IEEE 1394 “fire wire” cabling, or even wireless technologies including 802.11, ultra-wideband, and Bluetooth. The home server is capable of receiving commands from a wireless data enabled remote control, and in turn directly controlling other devices by sending control commands over such a data channel.

In a further particular embodiment, the wireless data enabled remote control includes a monochrome or color display sufficiently resolute to obtain configuration and/or device information.

In a particular embodiment, the remote control has an antenna coupled to a hand-held housing, a user interface, a display device, a processing unit, and a wireless data interface. The user interface may use a variety of input selection units located on one side of the hand-held housing. The processing unit may control the display and process speech input for transmission over the wireless data interface. The wireless data interface may communicate using various wireless standards including 802.11 (Wi-Fi), ultra-wideband (UWB), and Bluetooth™, among others. The wireless data interface may communicate with a residential gateway system. The residential gateway may have one or more interfaces to control appliances. These appliances may include kitchen appliances, lighting fixtures, and consumer electronics, among others. The remote control may also include a speech module such as a microphone. Using the speech module, speech commands may be communicated to the residential gateway system.

In a particular embodiment, the residential gateway appliance control system includes a remote control device interface, a broadband interface, a processing module, a first appliance communication interface, and a second appliance communication interface. The remote control device interface may also receive digitized speech commands. The processor module may process commands and transmit control commands through the appliance communications interfaces. The appliance communications interfaces may take various forms including communicating through a structured wiring interface within a residential unit, home audio and video type interfaces, infra-red interfaces, and home automation interfaces.

In another particular embodiment, a method for processing a remote command request to control an appliance is disclosed. The method includes the steps of receiving the remote command request at a residential gateway system, processing the received remote command request at the residential gateway system, and communicating to at least one appliance using an appliance communication interface. The appliance communication interface may take various forms including a structured wiring interface, a home audio and video type interface, and a home automation protocol interface.

### BRIEF DESCRIPTION OF DRAWINGS

FIGS. 1 and 2 depict exemplary embodiments of a remote control and a residential gateway system; and

FIGS. 3 and 4 depict exemplary methods of operation of the systems of FIGS. 1 and 2.

### DETAILED DESCRIPTION

As broadband gateways become more common in households, they represent a useful means for controlling and managing consumer electronics and home automation functions. With a single remote control or a web-based interface, a broadband gateway may be used to control a plurality of devices, home automation modules, and computer systems.

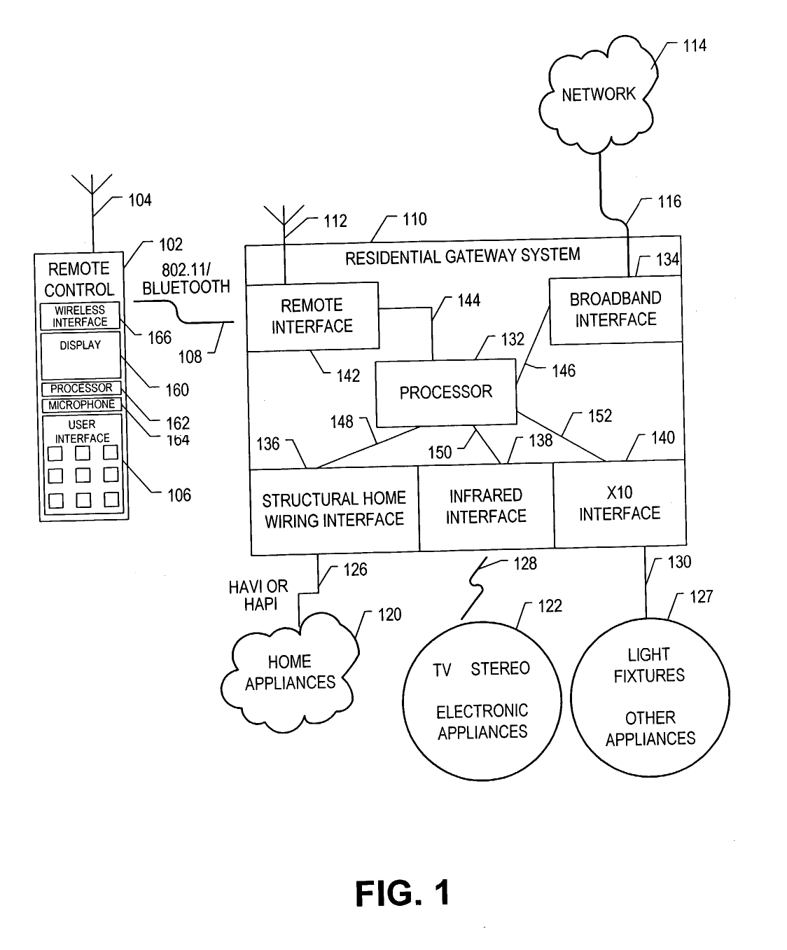

FIG. 1 depicts an exemplary embodiment of a system including a remote control 102 and a residential gateway system 110. The remote control 102 communicates with the residential gateway system 110 to control various appliances 120, 122 and 127. The residential gateway system 110 may be connected to a network 114, such as the Internet. With this system, more than one appliance can be controlled from the remote control 102 or from a web-based interface.

The remote control 102 includes a user interface 106 and an antenna 104. With the user interface 106, antenna 104, and other supportive circuitry, a user may interact with the residential gateway system 110 via a wireless data link 108. This wireless data link 108 may conform to standards and protocols such as (900 mHz, 2.4 GHz, etc.), 802.11 (Wi-Fi™), Bluetooth™, and ultra-wideband (UWB), among others. The remote control 102 may also have a microphone 164, processor 162, and display 160. The processor 162 may control the display 160, manage a wireless interface 166 to wireless data link 108, process speech input for transmission through the wireless interface 166, or perform any combination of these functions, among others. The display 160 provides visual interaction with a user. The display 160 may be used in conjunction with a graphical user interface. The display 160 may also be used to present HTML pages and network interaction. For example, the display 160 may be used to interact with the residential gateway system 110 through a web interface. The web interface may include a set of pages and scripts for configuring and controlling various devices including the residential gateway system 110 and various appliances. The web interface may be accessible through the remote control 102 or through the network 114.

The microphone 164 collects voice input. This voice input is processed by the processor 162. The processor 162 may interpret the voice input to determine a command. Alternately, the processor 162 may digitize the voice input and transmit it to the residential gateway system 110 where it is processed to determine a command.

The residential gateway system 110 receives input and commands from the remote control 102 and implements the commands through various interfaces to control various appliances. In general, the residential gateway system 110 may be implemented as a broadband gateway, modem, switch, router, or similar system. The residential gateway system 110 has a broadband interface 134 coupled to an external network 114, such as the Internet through communications line 116. The network 114 may be a global network, wide area network, or local area network, among others. The communications line 116 may take the form of a cable line, digital subscriber line, ISDN line, satellite network, or analog line, among others. The broadband interface 139 is also coupled to a processor 132 through internal bus 146.

In addition, the residential gateway system 110 has a remote interface 142 coupled to an antenna 112 and coupled to the processor 132 through line 144. While the embodiment shown has one processor 132 coupled to both the broadband interface 134 and the remote interface 142, two or more processors may be used. The remote interface 142 communicates with the remote control 102 through a wireless data link 108. This wireless data link 108 may conform to various protocols and standards including (900 mHz, etc.?), 802.11, Wi-Fi™, Bluetooth™, and ultra-wideband (UWB), among others. Through this wireless data link 108, the remote control 102 may send commands associated with various appliances.

The residential gateway system 110 receives these commands through the remote interface 142 and processes them using the processor 132. These commands may be text commands to be interpreted, signals to be translated or forwarded, or voice commands to be interpreted. The commands may take various alternate forms.

The processor 132 is also coupled to various communications interfaces such as a structural home wiring interface 136 through line 148, infrared interface 138 through line 150, or X10 interface 140 through line 152. The residential gateway system 110 may transmit commands to associated appliances through these interfaces, among others. For example, commands may be transmitted through phone lines, local area networks, power cables, and using various wireless frequencies, such as infrared and radio frequencies (RF) including 900 MHz, 2.4 GHz, and 5.0 GHZ among others. Furthermore the interfaces may conform to various home automation standards including X10, Home Audio/Video Interoperability (HAVi), Home API (HAPI), Vesa Home Network, Jini, Open Services Gateway Initiative (OSGi), and Universal Plugnplay (UPnP), among others.

For example, the residential gateway system 110 may transmit commands to electronic appliances such as audio and video equipment 122 through the infrared interface 138 and infrared signal 128. Alternately, the residential gateway system 110 may control light fixtures and other appliances 127 through an X10 interface 140 and line 130. In a further example, various home appliances 120 are controlled through a structural home wiring interface 136 and wiring 126. Various interfaces may be used to control various appliances including climate control devices, air conditioners, televisions, audio equipment, video equipment, light fixtures, kitchen appliances, and consumer electronics, among other equipment.

In this manner, the remote control 102 may universally control various appliances and home automation functionality through the residential gateway system 110. The residential gateway system 110 may also interact with the network 114 to provide an interface to appliances, the residential gateway system 110, and the remote control 102. For example, the residential gateway system 110 may acquire drivers and translators for appliances from resources on the network 114. In addition, the residential gateway system 110 may provide a web-based interface accessible by a browser on the network 114. The web-based interface may permit remote access for updating, control, and management of various appliances. In one example, a homeowner may access the residential gateway system 110 through the network to manipulate appliance settings.

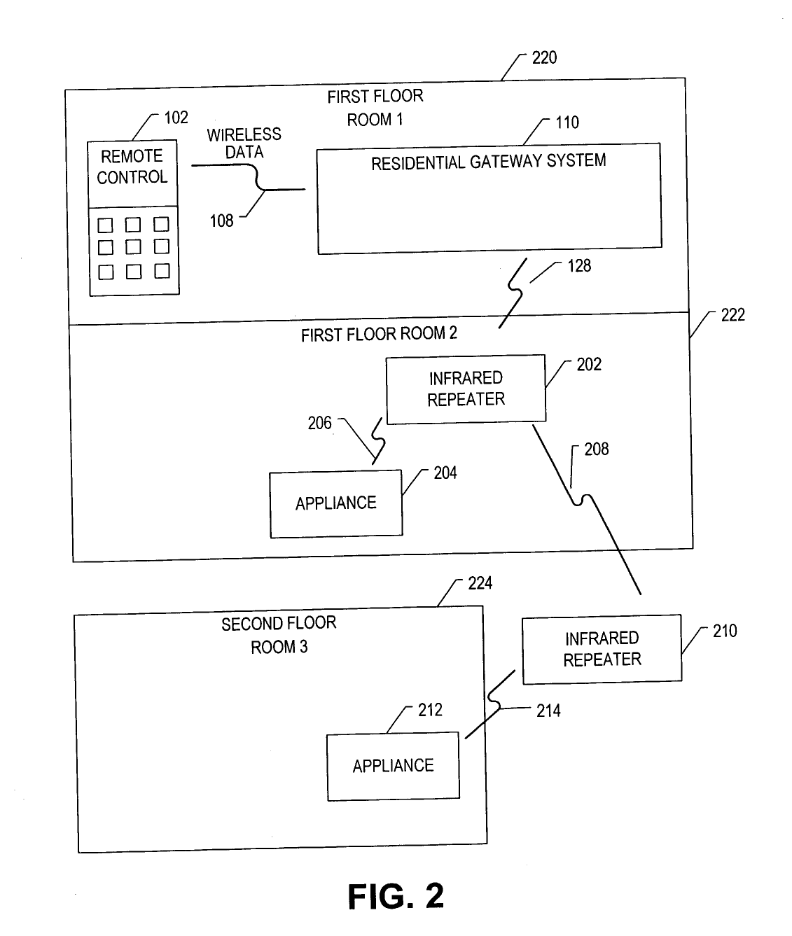

FIG. 2 depicts an exemplary embodiment of a structure utilizing the gateway system 110. In one room 220 of the structure, the wireless remote control 102 may transmit wireless data or commands 108 to the residential gateway system 110. The residential gateway system 110 then communicates control commands to a repeater 202 located in another room 222 via signal 128. Room 222 may be on the same floor as room 220. The repeater 202 communicates the control commands to a first appliance 204 using signal 206 or to another repeater 210 using signal 208. In this example, the repeater 210 transmits the control command to a second appliance 212 via signal 214. The second appliance 212 is located in a room 224 on a separate floor from rooms 220 and 222.

The example seen in FIG. 2 depicts the remote control 102 in the same room 220 as the residential gateway system 110. However, various communications standards and protocols permit wireless communication between rooms and the remote control 102 may be located in a different room. In addition, this example depicts control communications 128, 208 and 214 as infrared communications. Various other communications standards and protocols may be used to communicate between rooms and locations within a structure.

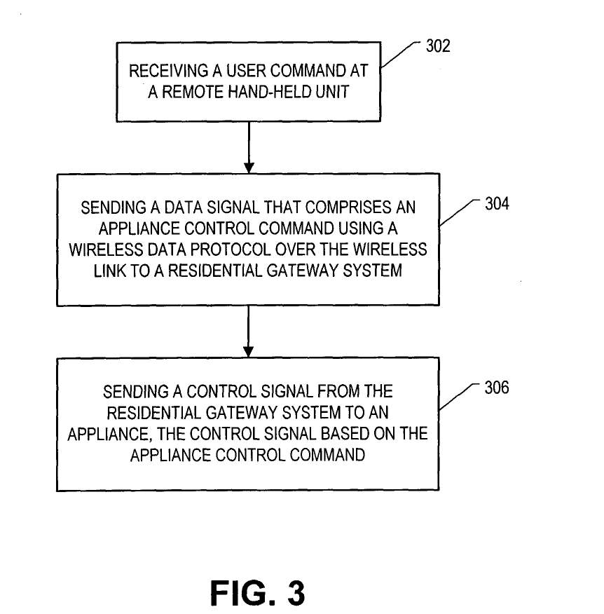

FIG. 3 depicts an exemplary method of using remote control 102 and residential gateway system 110. As shown in step 302, the hand-held remote control device receives a user command. The user command may include command entry through a button interface. Alternately, the user command may be a digitized voice command. As shown in step 304, a data signal associated with and responsive to the command is transmitted to the residential gateway system using a wireless link. The wireless link may utilize various protocols and standards such as (900 MHz, etc.), 802.11 (Wi-Fi™), Bluetooth™, and ultra-wideband (UWB), among others. The residential gateway system then sends a control signal based on the command to an appliance, as shown at step 306. The control signal may be sent through various interfaces including infrared, X10, structural wiring, and wireless interfaces, among others. The control signal may control various appliances such as climate control devices, air conditioners, televisions, audio equipment, video equipment, light fixtures, kitchen appliances, and consumer electronics, among other equipment.

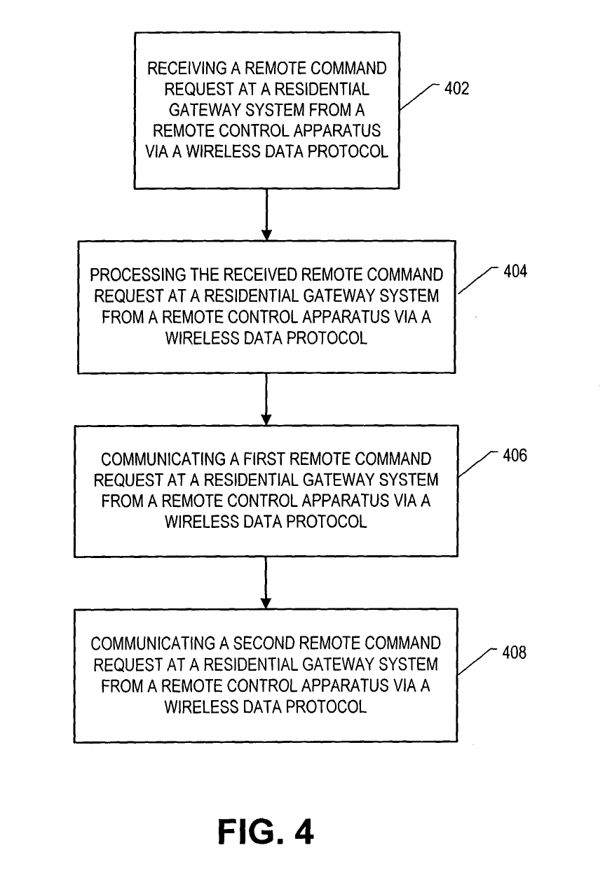

FIG. 4 depicts another exemplary method of using a residential gateway system. At step 402, the residential gateway system receives a command request from a remote control apparatus. The residential gateway system processes the command request as shown at step 404. The command request may be data or a digitized voice command. The residential gateway system translates the command request and transmits a first appliance command request as shown at step 406. The residential gateway system may also transmit a second command request as shown at step 408. For example, the residential gateway system may receive commands for turning on a television and dimming lights. The residential gateway system may, through an infrared interface, first send a command to control the television. The residential gateway system may also, through an X10 interface, send a command to control a light fixture. The residential gateway system may control multiple devices through a single interface or one device through more than one interface. Access repeaters and remote converters may also be used

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A remote control apparatus comprising:
a hand-held housing;
an antenna coupled to the hand-held housing;
a user interface including a plurality of input selection elements, each of the plurality of input selection elements accessible to a user selection from a first surface of the hand-held housing;
a wireless data interface disposed within the hand-held housing and coupled to the antenna, the wireless data interface to communicate via a wireless data protocol to a residential gateway system;
a display device capable of being updated by program logic; and
a processing unit to control the display to manage the wireless data interface, and to process speech input for transmission over the wireless data interface.

2. The remote control apparatus of claim 1, wherein the residential gateway system includes a broadband communication interface to a remote data network, an infrared wireless appliance interface to control a first set of electronic appliances, and a wireline appliance interface to control a second set of appliances.

3. The remote control apparatus of claim 2, wherein the second set of appliances includes kitchen appliances and light fixtures.

4. The remote control apparatus of claim 2, wherein the user interface includes a speech recognition module to receive and process user voice commands and wherein the processed voice commands may be communicated to the residential gateway system to control the first and second set of appliances.

5. The remote control apparatus of claim 1, wherein the user interface further includes a microphone to transmit speech commands.

6. The remote control apparatus of claim 5, wherein the speech commands are communicated to the residential gateway system.

7. The remote control apparatus of claim 1, wherein the wireless data protocol is one of 802.11, ultra-wideband (UWB), and Bluetooth.

8. A residential gateway appliance control system comprising:
a remote control device interface to receive remote commands from a remote control apparatus via a wireless data protocol;
a broadband interface to communicate with a remote data network;
a processing module responsive to the remote control device interface and responsive to the broadband interface;
a first appliance communication interface responsive to the processing module, the first appliance communication interface to control a first set of appliances via a first protocol; and
a second appliance communication interface responsive to the processing module, the second appliance communication interface to control a second set of appliances via a second protocol.

9. The residential gateway appliance control system of claim 8, wherein the first appliance communication interface is a structured wiring interface within a residential unit.

10. The residential gateway appliance control system of claim 9, wherein the second appliance communication interface is a home audio and video type of interface.

11. The residential gateway appliance control system of claim 9, wherein the second appliance communication interface is a home automation protocol interface.

12. The residential gateway appliance control system of claim 8, wherein at least one of the first and second interfaces is an infrared interface.

13. The residential gateway appliance control system of claim 12, wherein the infrared interface may be used to communicate a command via an infrared repeater to a controlled appliance located in a different room within a residence.

14. The residential gateway appliance control system of claim 13, wherein the controlled appliance is located in a different floor, such that the residential gateway appliance control system provides whole-house appliance control.

15. The residential gateway appliance control system of claim 8, wherein the remote control device interface receives digitized speech commands from the remote control apparatus, the digitized speech commands communicated over the wireless data protocol.

16. The residential gateway appliance control system of claim 15, wherein the wireless data protocol is one of 802.11, ultra-wideband (UWB), and Bluetooth.

17. The residential gateway appliance control system of claim 8, further comprising a built-in web server supported by the processing module, the built-in web server to facilitate remote access and control of at least one of the first and second set of appliances.

18. The residential gateway appliance control system of claim 17, wherein the remote access is provided via a remote internet browser interface coupled to the remote data network.

19. A method of processing a remote command request to control an appliance, the method comprising:
receiving the remote command request at a residential gateway system from a remote control apparatus via a wireless data protocol, the residential gateway system having a broadband interface to communicate with a remote data network;
processing the received remote command request at the residential gateway system;
communicating a first appliance control command using a first appliance communication interface to control at least one of a first set of appliances via a first protocol and selectively communicating a second appliance control command using a second appliance communication interface to control at least one of a second set of appliances via a second protocol.

20. The method of claim 19, wherein the first appliance communication interface is a structured wiring interface within a residential unit.

21. The method of claim 19, wherein the second appliance communication interface is one of a home audio and video type of interface and a home automation protocol interface.

22. The method of claim 19, wherein at least one of the first and second interfaces is an infrared interface and further comprising communicating a command via an infrared repeater to a controlled appliance located in a different room within a residence with respect to the location of the remote control apparatus.

23. The method of claim 19, further comprising receiving digitized speech commands from the remote control apparatus.

24. The method of claim 19, further comprising communicating broadband data over the broadband interface and wherein the broadband interface includes a digital subscriber line connection.

25. A method of communicating data via a wireless link, the method comprising:
receiving a user command at a remote control hand-held unit;
sending a data signal that comprises an appliance control command using a wireless data protocol over the wireless link to a residential gateway system; and
sending a control signal from the residential gateway system to an appliance, the control signal based on the appliance control command.

26. The method of claim 25, wherein the control signal is sent to the appliance using an infrared communication link.

27. The method of claim 25, further comprising receiving a second data signal at the remote control hand-held unit from the residential gateway system.

28. The method of claim 27, wherein the second data signal includes a remote control programming instruction.

29. The method of claim 25, further comprising receiving a data message of a computer network at the residential gateway system.

30. The method of claim 25, wherein the appliance is a television.

31. The method of claim 25, wherein the gateway system sends the control signal using an infrared repeater device.

32. The method of claim 25, further comprising receiving a user appliance addressing command that identifies an address corresponding to the appliance before receiving the user command.

33. The method of claim 32, wherein the user appliance addressing command is a voice command that identifies a location of the remote control hand-held unit.

34. A hand-held remote control apparatus for use with a residential gateway system, the hand-held remote control apparatus comprising:
a user command input module;
a user command processing element, the user command processing element coupled to the user command input module; and
a wireless data protocol communication module responsive to the user command processing element, the wireless data protocol communication module operative to communicate wireless data corresponding to a received remote control user input command over a wireless link to the residential gateway system.

35. A method of processing wireless data commands communicated from a remote control unit to a residential gateway system, the method comprising:
receiving a wireless data signal that comprises an appliance control command communicated from the remote control unit to the residential gateway system;
processing the appliance control command at the residential gateway system; and
sending a control signal from the residential gateway system to an appliance, the control signal based on the appliance control command.

36. The method of claim 35, further comprising sending the control signal to the appliance using an infrared communication link.

37. The method of claim 35, further comprising sending a second data signal to the remote control hand-held unit from the residential gateway system.

38. The method of claim 35, further comprising receiving and processing a data message communicated over a computer network, the data message received at the residential gateway system.

39. The method of claim 35, wherein the appliance is an electronic consumer electronics appliance.

40. The method of claim 35, further comprising acting on the appliance control command to transmit update information over the wireless data protocol for display on a display screen of the remote control unit.

41. The method of claim 40, where at least a portion of the update information transmitted to the remote control unit is obtained from a broadband interface of the residential gateway, accessing a remote data network.
